(19) United States
(12) Patent Application Publication
(10) Pub. No.: US 2009/0216959 A1
(43) Pub. Date: Aug. 27, 2009

(54) Multi Port Memory Controller Queuing

(76) Inventors: Brian David Allison, Rochester, MN (US); Joseph Allen Kirscht, Rochester, MN (US); Elizabeth A. McGlone, Rochester, MN (US)

Correspondence Address: Matthew C. Zehrer;IBM Corporation, Dept. 917, 3605 Highway 52 North, Rochester, MN, 55901-7829, US

(21) Appl. No.: 12/038,182

(22) Filed: Feb. 27, 2008

(51) Int. Cl. G06F 12/00

(52) U.S. Cl. 711/149; 711/E12.001

(57) ABSTRACT

The present invention is generally directed to a method, system, and program product wherein at least one command in a first queue is transferred to a second queue. When the first queue can no longer accept command(s) and a second queue is able to accept command(s), the second queue accepts the command(s) that the first queue can not. When the first queue is able to accept command(s), and there are command(s) in the second memory port that should have been in the first queue, the command(s) in the second queue are transferred to the first queue.

### RELATED FILINGS

The present invention is related to co pending application entitled, Multi Port Memory Controller Queuing, attorney docket number ROC920070593US1.

### FIELD OF THE INVENTION

The present invention generally relates to a memory controller, and more particularly, to a method, apparatus, and program product for improved queuing in a memory controller wherein at least one of the memory ports is not utilized (i.e., there is no DIMM or other type of memory module associated/installed with the at least one memory port).

### SUMMARY

Since the dawn of the computer age, computer systems have evolved into extremely sophisticated devices that may be found in many different settings. Computer systems typically include a combination of hardware (e.g., semiconductors, circuit boards, etc.) and software (e.g., computer programs). One key component in any computer system is memory.

Modern computer systems typically include dynamic random-access memory (DRAM). DRAM is different than static RAM in that its contents must be continually refreshed to avoid losing data. A static RAM, in contrast, maintains its contents as long as power is present without the need to refresh the memory. This maintenance of memory in a static RAM comes at the expense of additional transistors for each memory cell that are not required in a DRAM cell. For this reason, DRAMs typically have densities significantly greater than static RAMs, thereby providing a much greater amount of memory at a lower cost than is possible using static RAM.

It is increasingly more common in modern computer systems to utilize a chipset with multiple memory controller (MC) ports, each memory port being associated (i.e., contained in, connected to, etc.) with the necessary queue structures for memory read and write commands. During high level architecture/design process, queuing analysis is typically performed to determine the queue structure sizes necessary for the expected memory traffic. In this analysis, it is also determined at which point a full indication must be given to stall the command traffic to avoid a queue structure overflow condition. This is accomplished by determining the maximum number of commands that the queue structure must accept even after the queue structure asserts that it is full. Herein queue structures (i.e., registers, queue systems, queue mechanisms, etc.) are referred to as queues.

As the number of commands that a queue must sink during a given clock cycle is increased, the number of commands the queue must sink after asserting that it is nearly full increases. For example, if a queue only sinks 1 command per cycle and the pipeline feeding the queue is 3 clock cycles, then the queue needs to be able to sink up to 3 possible commands in the pipeline after asserting that it is nearly full. If the queue sinks up to 4 commands per cycle and the pipeline feeding the queue is 3 clock cycles, then the queue needs to be able to sink up to 12 possible commands after asserting that it is nearly full. Without sufficient queue depth, the full assertion will stall command traffic much more frequently resulting in adverse system performance affects.

In a computer system having at least two memory ports, system performance is optimized when the pair of memory ports is populated in balanced configuration. This results in at least two queues being utilized and the memory accesses being distributed relatively evenly across the pair of queues. If one or more of the available memory ports are not populated, the populated port's queue(s) must handle the additional load. This may result in the populated port's queues having to sink additional commands per clock cycle. Sinking more commands per cycle results in having to assert the nearly full condition when the queue is less full. This is done to leave room for more commands that may be in flight to the memory controller (i.e., mainline flow, etc.).

To realize sufficient system performance in a non-balanced configuration, queue size may be increase to minimize the frequency of queue full conditions. These additional queue entries may not be required in a balanced configuration. The additional queue entries may result for example in increased chip area, increased complexity for selecting commands from the queue, increased capacitive loading, increased wiring congestion and wire lengths, etc. These factors can make it difficult to perform all necessary function in the desired period of time which may ultimately result in adding additional clock cycles to the memory latency, which will adversely affect system performance.

The present invention is generally directed to a method, system, and program product wherein at least two memory ports are contained within a memory controller, and the memory controller being capable of being arranged in a unbalanced memory configuration (i.e., one populated memory module adjacent to an absent memory module, etc.). In an embodiment of the invention a command is transferred between the two memory ports. In other embodiments a command is transferred from a first memory port to a second memory port. In certain embodiments this may effectively expand the functional queue sizes in unbalanced memory configurations.

In a particular embodiment, a first memory port may become unable to sink commands (i.e., if the queue in the first memory port becomes full) and a second memory port may have availability (i.e., excess capacity, capacity to accept a new command, etc.) to sink commands. In a particular embodiment the second memory port may accept excess commands (i.e., commands otherwise accepted by the first memory port if the first memory port was available, etc.). In another embodiment when the first memory port has availability after a period of non-availability, and there are excess commands in the second memory controller, the excess commands are transferred to the first memory controller. In another embodiment when the first memory port has availability after a period of non-availability, and there are no excess commands in the second memory controller, the first memory port may accept commands for example from the mainline command flow. In certain embodiments, the transferring of excess commands effectively enlarges the first memory port's queue depth, allowing for an improved system performance affect.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system having at least one processor and a memory controller having at least one memory port in accordance with an embodiment of the present invention.

FIG. 2 illustrates a system for queue interconnection according to an embodiment of the present invention.

FIG. 3A illustrates an alternate queue interconnection scheme in accordance with an embodiment the present invention.

FIG. 3B illustrates another queue interconnection scheme in accordance with an embodiment of the present invention.

FIG. 4 illustrates a memory controller having four memory ports accordance with an embodiment of the present invention.

FIG. 5 illustrates a method to determine the manner of writing commands to local memory in accordance with an embodiment of the present invention.

FIG. 6 illustrates a method to determine the routing of commands through the queues of a memory controller in accordance with an embodiment the present invention.

FIG. 7 illustrates an article of manufacture or a computer program product in accordance with an embodiment of the present invention.

### DETAILED DESCRIPTION OF THE PREFERRED EMBODIMENTS

The present invention relates to a memory controller for processing data in a computer system. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiments shown but is to be accorded the widest scope consistent with the principles and features described herein.

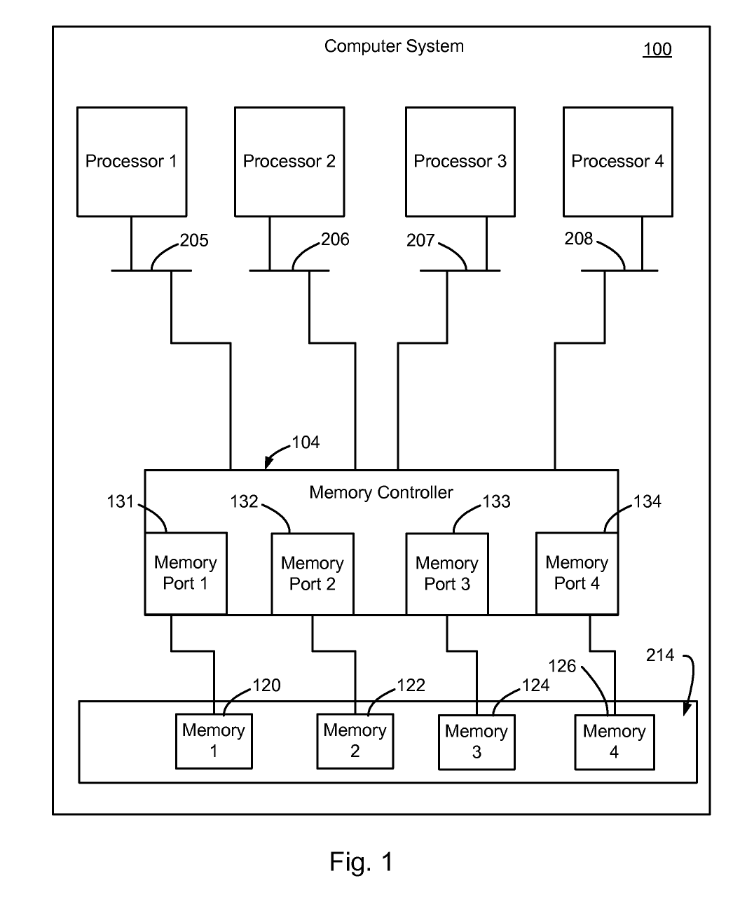

FIG. 1 is a block diagram of a computer system 100 including a memory controller 104 in accordance with an embodiment of the present invention. The computer system 100 may include one or more processors coupled to a memory controller 104 (described below), via one or more busses (i.e., bus 205-bus 208). More specifically, the computer system 100 comprises at least a first processor coupled to memory controller 104 via a bus 205 or other coupling apparatus. Computer system may also comprise a second processor connected to memory controller 104 via a bus 206, a third processor connected to memory controller 104 via a bus 207, and a fourth processor connected to memory controller via a bus 208. Alternatively more than one processor may be connected to memory controller 104 via any particular bus. Memory controller 104 may be external to each processor, or may be integrated in to the packaging of a module (not shown). The module may include each processor and the memory controller. Alternatively, the memory controller may be otherwise integrated into a processor. Although the computer system 100, as shown in FIG. 1, utilizes four processors, computer system may utilize a larger or smaller number of processors. Similarly, computer system 100 may include a larger or smaller number of busses than as shown in FIG. 1.

The memory controller 104 may be coupled to a local memory (e.g., one or more DRAMs, DIMM, or any such alternate memory module) 214. The memory controller 104 may include a plurality of memory ports (i.e., first memory port 131, second memory port 132, third memory port 133, and fourth memory port 134) for coupling to the local memory 214. For example, each memory port 131-134 may couple to a respective memory module (e.g., DRAM, DIMM, or any such memory module) 120-126 respectively, included in the local memory 214. In other words memory modules may be populated into computer system 100. Although the memory controller 104 includes four memory ports, a larger or smaller number of memory ports may be employed. The memory controller 104 is adapted to receive requests for memory access and service such requests. While servicing a request, the memory controller 104 may access one or more memory ports 131-134. In alternate embodiments, the memory controller 104 may include any suitable combination of logic, registers, memory or the like, and in at least one embodiment may comprise an application specific integrated circuit (ASIC).

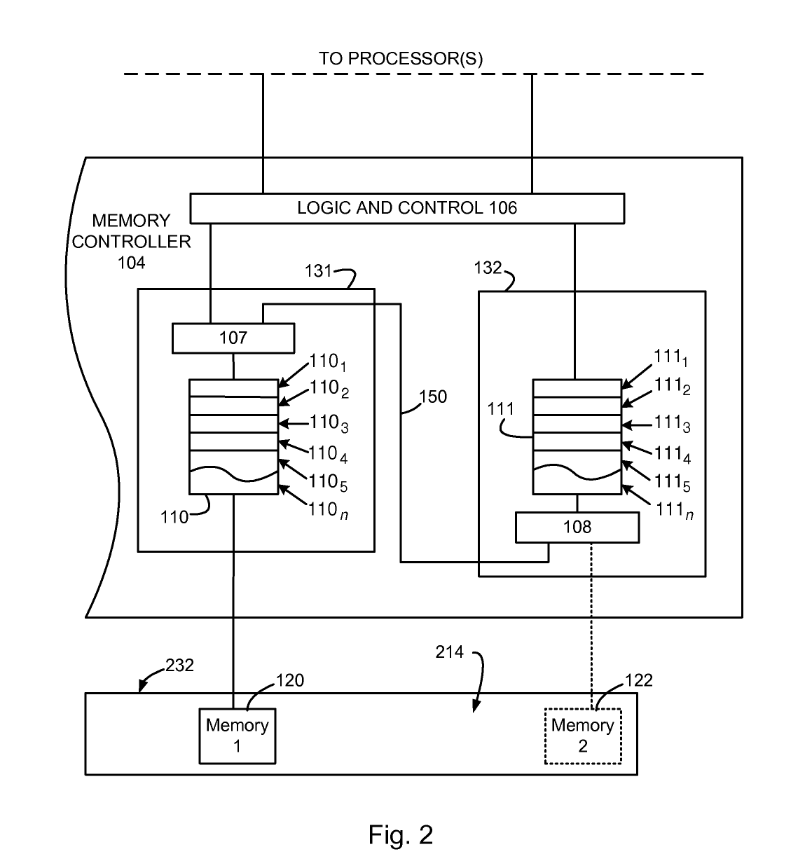

FIG. 2 illustrates a system for queue interconnection according to an embodiment of the present invention. More specifically, FIG. 2 illustrates interconnected queue 11 0 and 111 in accordance with an embodiment of the present invention. In the illustrated embodiment the memory configuration is unbalanced, wherein memory module 120 is utilized (i.e., present, installed, populated, etc.) and memory module 122 is unutilized (i.e., not present, not installed, not populated, etc.).

Memory controller 104 comprises logic and control (i.e., 106, 107, and 108), a first memory port 131, and a second memory port 132, herein referred to as memory port 131 and memory port 132 respectively. A queue 110 is associated (i.e., contained in, connected to, linked to, etc) with memory port 131 and queue 111 is associated with memory port 132. Memory controller 104 receives commands from processors 204 and writes those commands to local memory 214. In a particular embodiment these commands may be altered (e.g., reformatted to a correct command format to allow the command to sink) in memory controller 104, resulting in related commands being written to memory module 120 rather than the actual commands from processors 204 written to memory module 120.

In a particular embodiment, there are numerous memory ports within memory controller 104, though only two are shown in FIG. 2 (memory ports 131 and 132). In a particular embodiment queues 110 and 111 are queues having similar queue properties (e.g., queue type, queue size, arbitration schemes employed, etc.). In an alternative embodiment the queues 110 and 111 are queues having different queue properties. Queue 110 and 111 have multiple queue entries. As shown, in FIG. 2, queue 110 has “n” queue entries 110₁-110ₙ and queue 111 has “n” queue entries 111₁-111ₙ.

Upon memory controller 104 receiving commands from at least one processor, the commands are routed, processed, or otherwise controlled by logic and control 106. Logic and control 106 is an element that controls what memory port command(s) shall be routed. Logic and control 107 is an element that controls which command enters a queue. Logic and control 108 is an element that controls the routing of a command exiting a queue. Though only one of each logic and control 107 and 108 are shown, in other embodiments multiple logic and controls 107 and 108 may be utilized. In still other embodiments logic and control 106, 107, and 108 may be combined or otherwise organized.

Memory module 120 may be utilized and receiving commands from memory controller 104. Likewise, memory module 122 is unutilized and is not receiving commands from memory controller 104. This configuration is an example of an unbalanced memory configuration. In prior designs, because memory module 122 was unutilized, memory port 132 did not accept commands.

In a particular embodiment, after some time of operation, each queue entry 110₁-110ₙ is full, is giving a nearly full signal, is slowing in accepting new commands, or is not accepting new commands. In many instances, one or more commands are directed to queue 110, when queue 110 is full/nearly full. These one or more commands are herein referred to as excess commands, and this situation is referred to as an excess situation. In previous designs these excess commands were not routed through the memory port until the queue 110 had sinked a command, or had otherwise gained capacity to accept an excess command.

In accordance with the present invention, instead of waiting for queue 110 to sink a command (i.e., queue 110 is no longer full), the excess commands are written to queue 111 and subsequently transferred to queue 110. The excess commands are written to queue 111 until queue 111 is itself full or until queue 110 is no longer full. Upon queue 110 no longer being full, the one or more excess commands are transferred from the queue 111 to queue 110. In a particular embodiment, if both queue 110 and queue 111 are full, no other new commands can be sinked by the queues 110 and 111. In another embodiment, command prioritization may be utilized to affect how the commands are routed through the multiple memory ports.

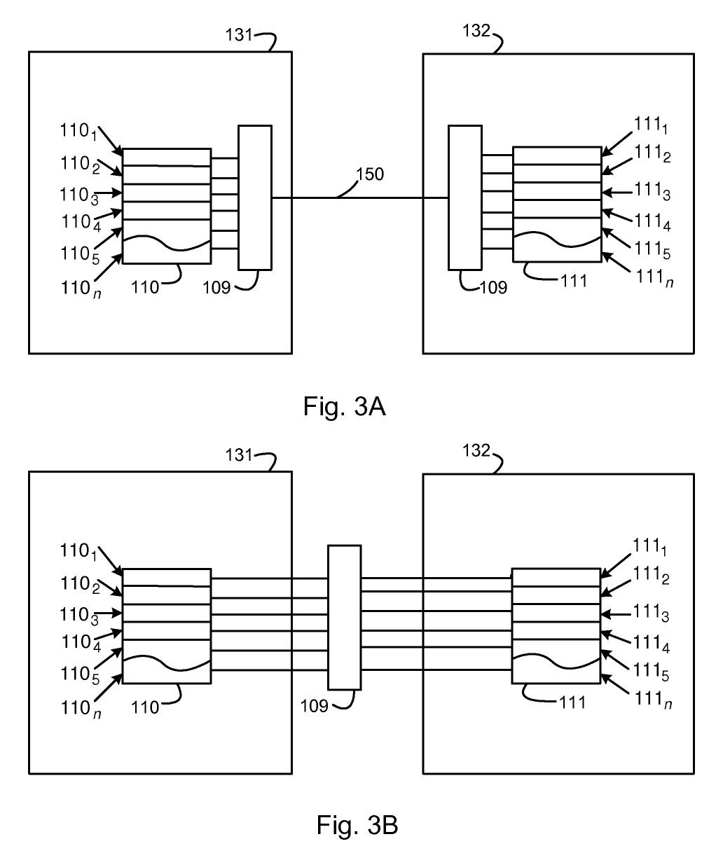

Queue-to-queue interface 150 logically connects queue 110 and queue 111. Queue-to-queue interface 150 is subsystem (i.e., a bus, a wide bus, etc.) that transfers data that is stored in one queue to another queue. In a particular embodiment multiple Queue-to-queue interfaces 150 are utilized to connect queues 110 and 111. When queue 110 is no longer full, the excess command(s) (if present in queue 111) are transferred from queue 111 to an empty queue entry/entries 110₁-110₅. In the embodiment shown in FIG. 2, queue entry 111ₙ is connected to queue entry 110₁ by Queue-to-queue interface 150. In an alternative embodiments, any of the of queue entries 110₁-110ₙ may be connected to any of the queue entries 111₁-111ₙ. In yet another embodiment, as shown in FIGS. 3A and 3B, any such queue entry(s) 110₁-110ₙ may be attached to any other such queue entry(s) 111₁-111ₙ. Queue 110 and queue 111 may be interconnected via queue-to-queue interface 150 and the transfer of commands may be controlled by logic and control 109. Logic and control 109 may be the combination of logic and control 106, 107, and 108. Logic and control 109 may also be a separated element from other logic and control elements 106, 107, and 108. In another embodiment queue 110 and queue 111 may be interconnected utilizing any queue interconnection scheme. In the present embodiments logic and control 109 decides and controls from which entry to transfer from and to which entry to transfer to. In a particular embodiment memory controller 104 may be integrated into a particular processor or into the package of one or more processor modules.

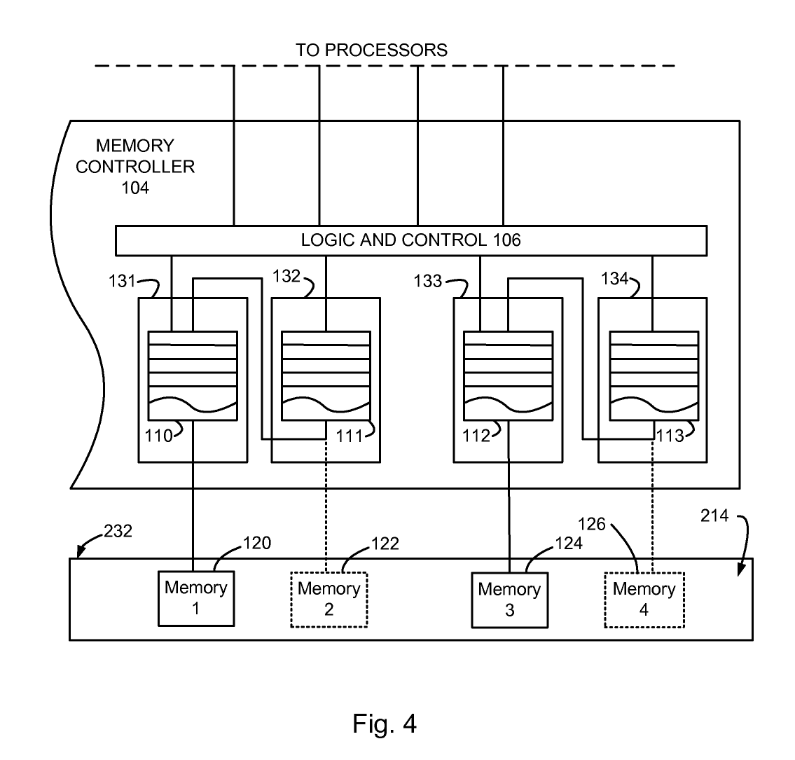

FIG. 4 illustrates memory controller 104 controlling at least four memory ports 131, 132, 133, 134 in accordance with the present invention. In a particular embodiment queues 110 and 111 and queues 112 and 113 are connected to each other respectively. FIG. 4 also depicts an unbalanced memory configuration. In a particular embodiment there is one present memory module per each two memory ports having interconnected queues. In FIG. 4, memory ports 131 and 132 utilize respectively a utilized memory module 120 (i.e., a memory module is present) and unutilized memory module 122 (i.e., a memory module is not present), and memory ports 133 and 134 utilize respectively, a utilized memory module 124 and unutilized memory module 126. It is possible to have two memory modules present in the memory port pair having interconnected queues. However, it is preferred to have one memory module present in each memory port pair.

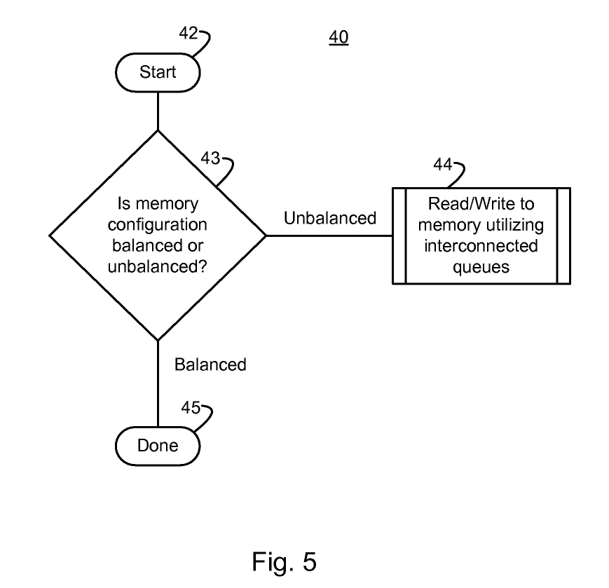

FIG. 5 illustrates a method 40 to determine the manner of writing commands to local memory. Method 40 starts (block 42) when at least one memory module is installed into a computer system. The memory module is installed in a unbalanced memory configuration in accordance with the present invention. It is determined whether the memory configuration will result in a balanced memory configuration or whether the memory configuration will result in an unbalanced memory configuration (block 43). If the memory configuration is projected to always result in a balanced memory configuration, commands are written to local memory as previously known (block 45). If the memory configuration may result in an unbalanced memory configuration, commands are written to the one or more memory modules, in accordance with the present invention (block 44).

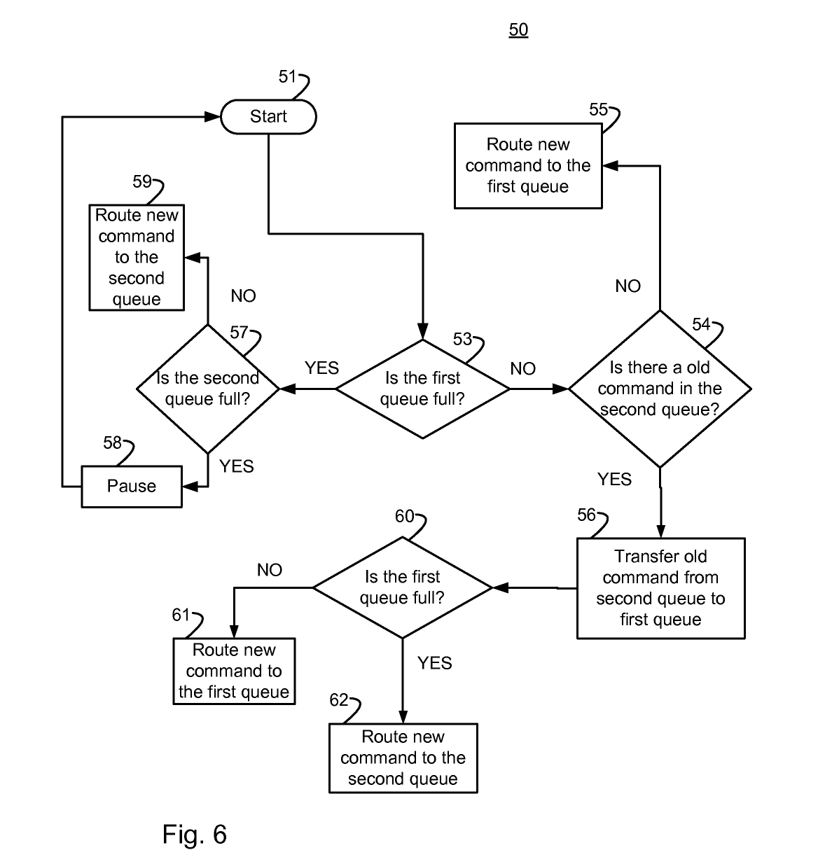

FIG. 6 illustrates a method 50 used to determine the routing of commands through the queues of one or more memory port(s), in an unbalanced memory configuration. Method 50 starts (block 51) when at least one new command is to be routed through at least one memory port. In order to determine which memory port to route the new command through, it is determined if the first queue in the first memory port is full (block 53). If the first queue in the first memory port is full, it is determined if the second queue in the second memory port is full (block 57). If the second queue in the second memory port is full, method 50 should pause (block 58) until either the first queue in the first memory port or the second queue in the second memory port is not full. If the second queue in the second memory port is not full, the new command(s) is routed to or through the second queue (block 59). If the first queue in the first memory port is not full, it is determined whether there is a previous command in the second queue (block 54). If there is a previous command in the second queue, and the first queue is not full, the previous command is transferred from the second queue to the first queue (block 56). If the previous command is transferred from the second queue to the first queue, it is determined which queue to route the new command to or through. If the first queue is full (block 60), the new command is routed to the second queue (block 62). If the first queue is not full, the new command is routed to the first queue (block 61). If there is not a previous command in the second queue, and the first queue is not full, the new command(s) is routed to or through the first queue (block 55).

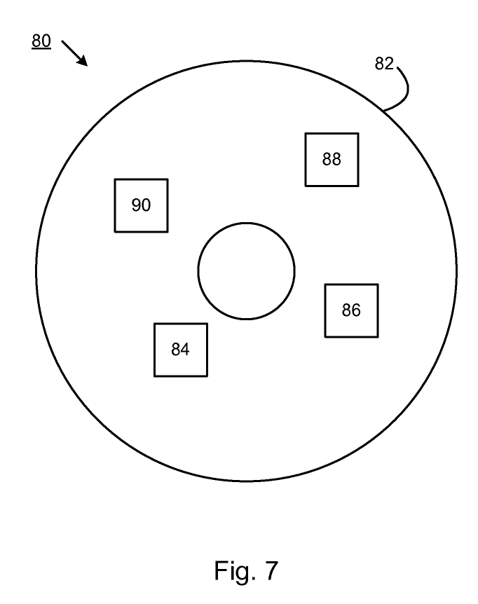

FIG. 7 depicts an article of manufacture or a computer program product 80 of the invention. The computer program product 80 includes a recording medium 82, such as, a non-volatile semiconductor storage device, a floppy disk, a high capacity read only memory in the form of an optically read compact disk (e.g., CD-ROM, DVD, etc.), a tape, a transmission type media such as a digital or analog communications link, or a similar computer program product. Recording medium 82 stores program means 84, 86, 88, and 90 on medium 82 for carrying out the methods for providing multi port memory queuing, in accordance with at least one embodiment of the present invention. A sequence of program instructions or a logical assembly of one or more interrelated modules defined by the recorded program means 84, 86, 88, and 90, direct the computer system for providing memory queuing.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Therefore, it is desired that the embodiments described herein be considered in all respects as illustrative, not restrictive, and that reference be made to the appended claims for determining the scope of the invention.

The invention claimed is:

1. A memory system comprising:
a memory controller comprising a first memory port associated with a first queue and a second memory port associated with a second queue, and;
at least a first memory module connected to the first memory port;
at least one logic control element configured to control the routing of a command, and;
wherein the second queue is configured to accept the command that is to be routed to the first memory module.

2. The memory system of claim 1 wherein a second memory module is not connected to the second memory port.

3. The memory system of claim 2 wherein the second queue accepts the command only after the first queue is full.

4. The memory system of claim 3 wherein after the command is accepted it is subsequently transferred from the second queue to the first queue upon at least an existing command exiting the first queue.

5. The memory system of claim 4 wherein the memory controller is external to a processor, and wherein the memory controller is configured to accept commands from the processor.

6. The memory system of claim 4 wherein the memory controller is integrated in a processor, and wherein the memory controller is configured to accept commands from the processor.

7. The memory system of claim 6 wherein the first queue and the second queue are interconnected.

8. The memory system of claim 6 wherein the first queue logically shares one or more queue entries with the second queue.

9. The memory system of claim 3 wherein the second queue accepts the command only after the second queue is not full.

10. The memory system of claim 9 wherein the command is transferred from the second queue to the first queue upon at least an existing command exiting the first queue.

11. The memory system of claim 10 wherein the first queue logically shares one or more queue entries with the second queue.

12. A method of routing commands to a memory module utilizing a first queue and a second queue comprising the steps of:
routing a command stream to a first memory module through a first queue, the first queue contained in a first memory port, and;
if the first queue is full, routing at least one subsequent command through a second queue, the second queue contained in a second memory port.

13. The method of claim 12 further comprising the steps of:
upon the first queue no longer being full, routing the subsequent command to the first memory module.

14. The method of claim 12 further comprising the steps of:
upon the first queue no longer being full, transferring the subsequent command from the second queue to the first queue.

15. The method of claim 14 further comprising the steps of:
routing the subsequent command to the first memory module.

16. The method of claim 15 wherein the first queue logically shares one or more queue entries with the second queue.

17. A computer program product for enabling a computer to route commands to a memory module comprising:
computer readable program code causing a computer to:
route a command stream through a first queue to a first memory module, the first queue contained in a first memory port, the first memory port contained in a memory controller, and;
if the first queue is full, route at least one subsequent command through a second queue, the second queue contained in a second memory port, the second memory port contained in the memory controller.

18. The program product of claim 17, wherein the computer readable program code further causes the computer to:
upon the first queue no longer being full, route the subsequent command to the first memory module.

19. The program product of claim 17 wherein the computer readable program code further causes a computer to:
transfer the subsequent command from the second queue to the first queue, upon the first queue not being full.

20. The program product of claim 19 wherein the computer readable program code further causes a computer to:
route the subsequent command to the first memory module.
